(19) United States
(12) Patent Application Publication
(10) Pub. No.: US 2021/0174462 A1
(43) Pub. Date: Jun. 10, 2021

(54) HEALTH BASED PROPERTY EVALUATION

(71) Applicant: INTERNATIONAL BUSINESS MACHINES CORPORATION, ARMONK, NY (US)

(72) Inventors: Nadiya Kochura, Bolton, MA (US); Fang Lu, Billerica, MA (US)

(21) Appl. No.: 16/702,779

(22) Filed: Dec. 4, 2019

(51) Int. Cl. G06Q 50/16; G06Q 30/06

(52) U.S. Cl. CPC G06Q 50/163; G06Q 30/0631; G06Q 30/0627; G06Q 30/0607

(57) ABSTRACT

A method, a computer program product, and a computer system evaluate a prospective property based on a health state of a user. The method includes receiving a selection of the prospective property. The method includes determining one or more considerations based on health information specific to the user. The one or more considerations are indicative of one or more conditions that impact habiting the prospective property. The method includes determining habitation conditions based on property information of the prospective property. The habitation conditions are indicative of property conditions that are present at the prospective property. The method includes determining whether the prospective property is acceptable to the user based on the one or more considerations and corresponding ones of the habitation conditions. The method includes transmitting an indication indicating a result of the determining whether the prospective property is acceptable to the user.

### BACKGROUND

The exemplary embodiments relate generally to evaluating properties, and more particularly to determining a tolerance of a user to occupy a property based on health considerations.

People have different health, physical, and social conditions that require different property conditions for locations that the people may occupy for a given period of time. When renting or purchasing property, a person may consider a plurality of different conditions that satisfy certain requirements that the person may wish the property to have. For example, the person may require certain property characteristics (e.g., kitchen requirements, bedroom and/or bathroom requirements, etc.). However, the property may have unforeseen characteristics that may not be readily known to the person prior to any decision making process. For example, the property may have health based concerns to the person that may prevent a safe or comfortable occupation of the space. With the needs being varied from one person to the next, there is not be a standardized reporting of the property that is specific to the prospective renter or purchaser of the property.

### SUMMARY

The exemplary embodiments disclose a method, a computer program product, and a computer system for evaluating a prospective property based on a health state of a user. The method comprises receiving a selection of the prospective property. The method comprises determining one or more considerations based on health information specific to the user. The one or more considerations are indicative of one or more conditions that impact habiting the prospective property. The method comprises determining habitation conditions based on property information of the prospective property. The habitation conditions are indicative of property conditions that are present at the prospective property. The method comprises determining whether the prospective property is acceptable to the user based on the one or more considerations and corresponding ones of the habitation conditions. The method comprises transmitting an indication indicating a result of the determining whether the prospective property is acceptable to the user.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of a property evaluation system 100, in accordance with the exemplary embodiments.

FIG. 2 depicts an exemplary flowchart of a method illustrating the operations of a recommendation program 142 of the property evaluation system 100 in evaluating a property based on a health state of the user, in accordance with the exemplary embodiments.

FIG. 3 depicts an exemplary block diagram depicting the hardware components of the property evaluation system 100 of FIG. 1, in accordance with the exemplary embodiments.

FIG. 4 depicts a cloud computing environment, in accordance with the exemplary embodiments.

FIG. 5 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

The exemplary embodiments are directed to a method, computer program product, and system for evaluating a property based on a health state specific to a user. As will be described in greater detail herein, the exemplary embodiments are configured to utilize a user profile that indicates one or more health related conditions of the user that may impact whether a property is appropriate for occupation. The exemplary embodiments are also configured to utilize a property profile that indicates one or more habitation conditions to determine whether the property is appropriate for the user according to the health related conditions of that user. The exemplary embodiments provide a proactive approach to evaluate the property in a personalized manner as each user may have health related conditions or other considerations that affect a quiet and comfortable habitation of a property. Key benefits of the exemplary embodiments may include personalizing a proactive approach in identifying properties that are habitable by a user as requirements and preferences vary from one user to the next so that a user is aware of habitation conditions prior to further consideration and possible binding terms being reached. Detailed implementation of the exemplary embodiments follows.

Conventional approaches to evaluating a property are directed towards identifying conditions that are imposed by regulations and/or laws. For example, a conventional approach may entail determining mold conditions through humidity and temperature readings. While mold is a habitation condition that is of concern, this concern applies to any user who is looking into the property and not personalized to a specific person. In another example, a conventional approach may entail inspecting indoor air quality through odor, chemicals, microscopic airborne particulates, carbon monoxide, etc. However, again, these habitation conditions apply to any user and is not personalized to a specific person. In a further example, a conventional approach may determine alarm conditions based on water leakages and water conditions. Once again, such a habitation condition is applicable to any user considering a property.

Other conventional approaches may evaluate a property based on allergen conditions. For example, a conventional approach may utilize an allergen detector to provide an alarm indication when allergies or hypersensitivity reactions may occur. In another example, a conventional approach may monitor transient local conditions including local air quality and allergen levels to timely generate a patient-specific alert. However, allergens and hypersensitivity is only one aspect that should be considered when evaluating a property for habitation by a user.

Further conventional approaches may determine how to react to a user occupying a property. For example, in a conventional approach, a building may be configured to anticipate problem conditions and take steps to eliminate the problem for a user who has entered a property. However, with the user already inside the property, the conventional approach must now reactively determine solutions to potential problems.

The exemplary embodiments are described with regard to proactively evaluating a property based on a health state that is specific to a user. Accordingly, the property as used in the exemplary embodiments are directed to a prospective property that is being considered for habitation purposes by the user. As will be described below, the health state may encompass a variety of factors including a health condition (e.g., allergy conditions triggered by humidity, animal fur, etc., a sensitivity to strong smells, loud noises, strong lights, etc. that may trigger a migraine, etc.), a physical condition (e.g., a physical handicap), a social condition (e.g., certain sounds and lights that may trigger anxiety), etc. Accordingly, the health state used herein may incorporate these various conditions that are specific to the user. The exemplary embodiments being directed toward a property and a health state is also only illustrative. The exemplary embodiments may be utilized and/or modified to proactively evaluate any potential object or intangible product (e.g. a service) based on personalized factors of a user considering the potential object or intangible product. The property may also relate to a property being purchased, occupied for a short duration, occupied for an extended duration, etc.

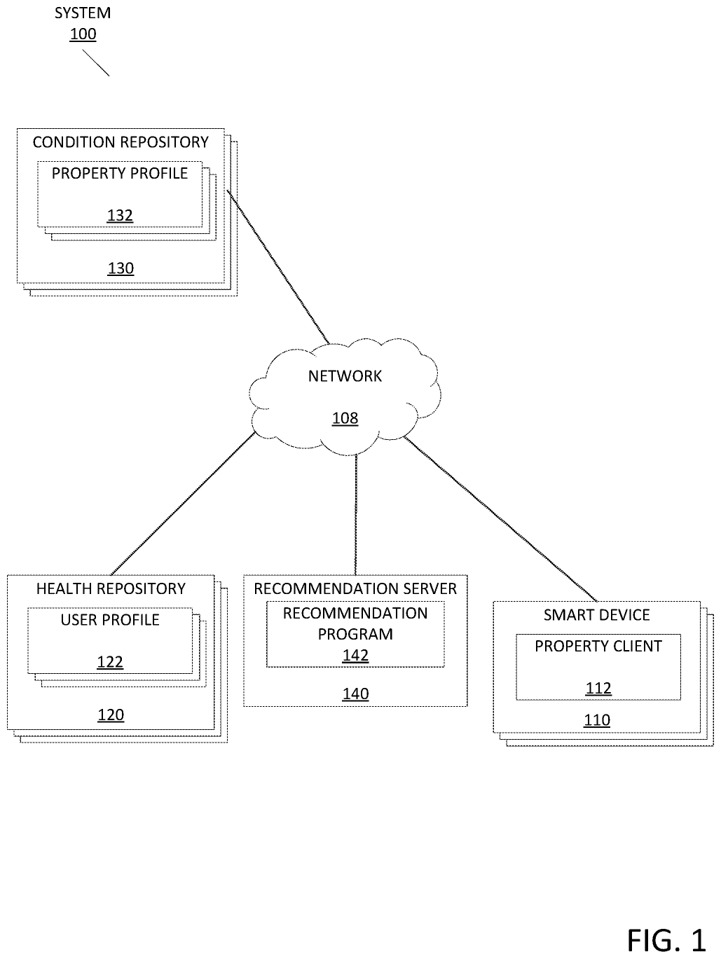

FIG. 1 depicts a property evaluation system 100, in accordance with the exemplary embodiments. According to the exemplary embodiments, the property evaluation system 100 may include one or more smart devices 110, one or more profile repositories 120, one or more condition repositories 130, and a recommendation server 140, which may all be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted.

In the exemplary embodiments, the network 108 may be a communication channel capable of transferring data between connected devices. Accordingly, the components of the property evaluation system 100 may represent network components or network devices interconnected via the network 108. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc. which may be implemented as an intranet network, a local area network (LAN), a wide area network (WAN), or a combination thereof. In further embodiments, the network 108 may be a Bluetooth network, a WiFi network, or a combination thereof. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices. For example, the network 108 may also represent direct or indirect wired or wireless connections between the components of the property evaluation system 100 that do not utilize the network 108.

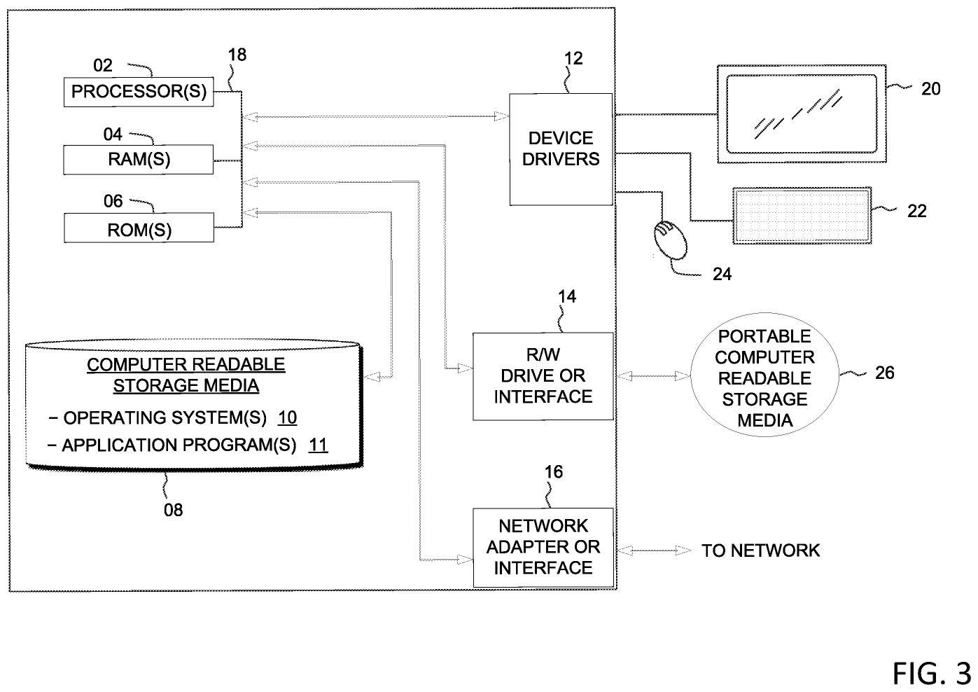

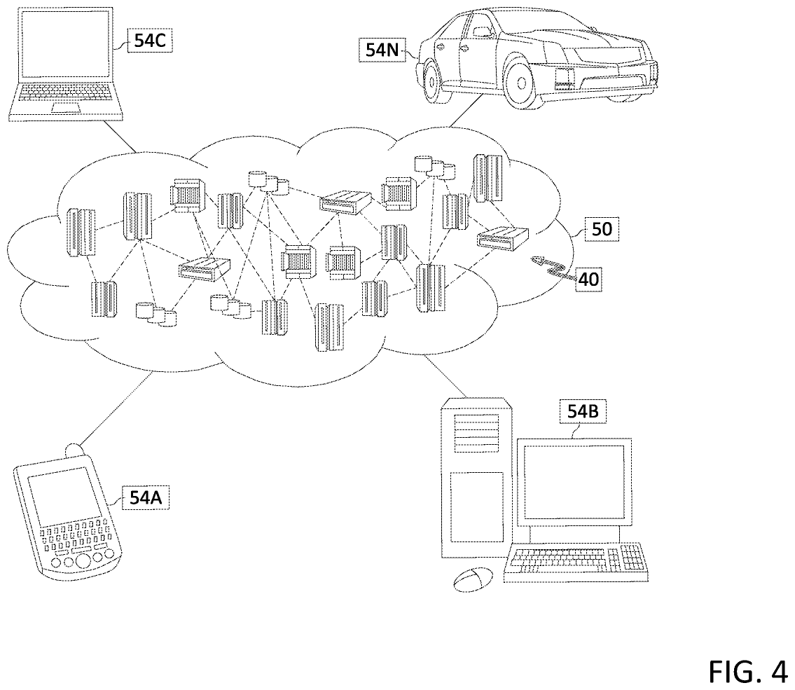

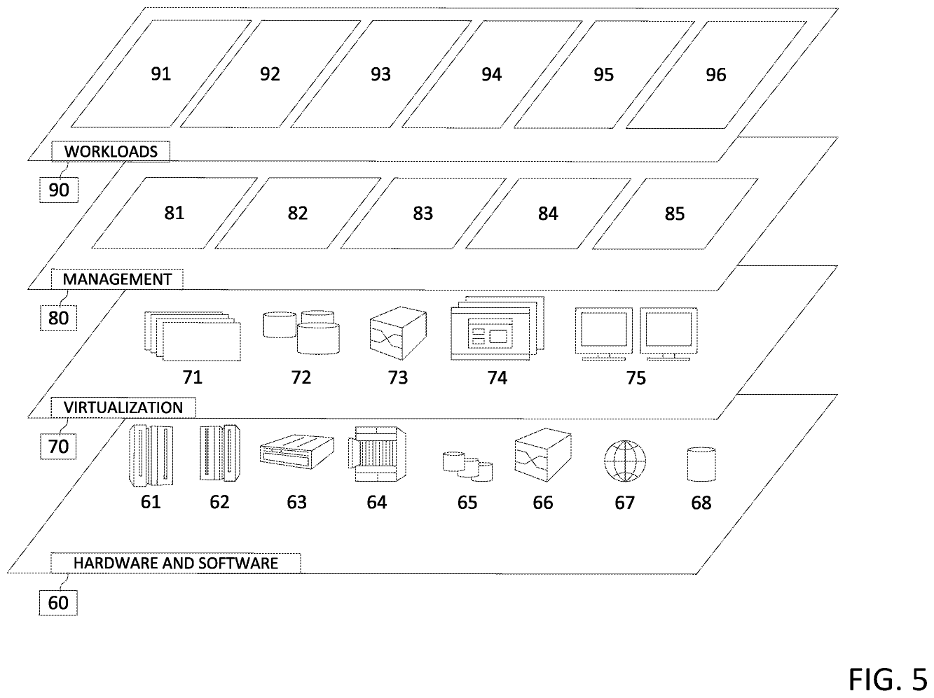

In the exemplary embodiments, the smart device 110 may include a property client 112 and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an Internet of Things (IoT) device, or any other electronic device or computing system capable of receiving and sending data to and from other computing devices. While the smart device 110 is shown as a single device, in other embodiments, the smart device 110 may be comprised of a cluster or plurality of computing devices, in a modular manner, etc., working together or working independently. The smart device 110 is described in greater detail as a hardware implementation with reference to FIG. 3, as part of a cloud implementation with reference to FIG. 4, and/or as utilizing functional abstraction layers for processing with reference to FIG. 5.

In the exemplary embodiments, the property client 112 may act as a client in a client-server relationship and may be a software, hardware, and/or firmware based application capable of providing a list of available properties via the network 108. In embodiments, the property client 112 may operate as a user interface allowing the user of the smart device 110 to interact with one or more components of the property evaluation system 100, and utilize various wired and/or wireless connection protocols for data transmission and exchange associated with joining the meeting, including Bluetooth, 2.4 gHz and 5 gHz internet, near-field communication, Z-Wave, Zigbee, etc.

The property client 112 may maintain a database of properties that may be searched and filtered for viewing by the user of the smart device 110. The property client 112 may be configured to receive property listings from a plurality of sources (e.g., realty companies). The property listings may be received with information about the property as well as images of the property. The property client 112 may also be configured to ascertain the property information (e.g., through a public records database) and the images (e.g., publicly available street and satellite images). In an alternative exemplary embodiment, the property client 112 may utilize third party engines or sources to collect the list of available properties to be viewed by the user of the smart device. In a further alternative exemplary embodiment, the user of the smart device 110 may utilize a different application (e.g., a web browser) to search for available properties. The property client 112 may be configured to determine when such an application is in use to provide the features of the exemplary embodiments. Accordingly, inputs made on the application may be received and processed by the property client 112. As the property being considered may be for a variety of purposes such as for purchase (e.g., realty listings), for long term durations (e.g., a lease or rental agreement), for short term durations (e.g., a hotel room, a vacation rental, etc.), etc., the property client 112 may present property listings that correspond to the request regarding a duration of habitation of the property.

In providing a list of the available properties to the user of the smart device 110, the property client 112 may receive a selection of one or more properties that the user may be interested in considering. For example, the user may select a property based on initial considerations based on a written description and/or images of the property that is supplied with the list of available properties. The initial considerations may be, for example, an asking price, a layout, a number of bedrooms, a number of bathrooms, handicap accessibility, property taxes, etc. Upon receiving the selection, the property client 112 may transmit the selected property for further processing, as will be described in detail below.

In the exemplary embodiments, the health repository 120 may include one or more user profiles 122 and may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of storing, receiving, and sending data to and from other computing devices. While the health repository 120 is shown as a single device, in other embodiments, the health repository 120 may be comprised of a cluster or plurality of electronic devices, in a modular manner, etc., working together or working independently. While the health repository 120 is also shown as a separate component, in other embodiments, the health repository 120 may be incorporated with one or more of the other components of the property evaluation system 100. For example, the health repository 120 may be incorporated in the recommendation server 140. Thus, access to the health repository 120 by the recommendation server 140 may be performed locally. In another example, the health repository 120 may be incorporated in the smart device 110 (e.g., each smart device 110 has a health repository 120 including at least the user profile 122 of the user who is respectively associated). Thus, access to the health repository 120 and to a specific one of the user profiles 122 may be performed through a transmission from the smart device 110. The health repository 120 is described in greater detail as a hardware implementation with reference to FIG. 3, as part of a cloud implementation with reference to FIG. 4, and/or as utilizing functional abstraction layers for processing with reference to FIG. 5.

In the exemplary embodiments, the user profiles 122 may be associated with users of the smart devices 110 who are utilizing the features of the exemplary embodiments. The user profiles 122 may be populated with information that is manually provided by the user. The user profiles 122 may also be populated with information that is automatically determined based on various types of available information such as an electronic medical record (EMR). The user profiles 122 may further be populated with information gathered by sensors (not shown) regarding the health state of the user. When receiving the health information of the users to generate the user profiles 122, the health repository 120 and/or other components of the property evaluation system 100 may be configured to comply with the Health Insurance Portability and Accountability Act (HIPAA) as well as utilize security mechanisms to ensure that the health information included in the user profiles 122 remain in a secure manner. The types of information that may be included in the user profiles 122 may include, for example, health information (e.g., conditions, allergies, diseases, etc.), physical information (e.g., physically related conditions), social information (e.g., mental conditions, triggerable conditions, etc.), etc.

In the exemplary embodiments, the condition repository 130 may include one or more property profiles 132 and may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of storing, receiving, and sending data to and from other computing devices. While the condition repository 130 is shown as a single device, in other embodiments, the condition repository 130 may be comprised of a cluster or plurality of electronic devices, in a modular manner, etc., working together or working independently. While the condition repository 130 is also shown as a separate component, in other embodiments, the condition repository 130 may be incorporated with one or more of the other components of the property evaluation system 100. For example, the condition repository 130 may be incorporated in the recommendation server 140. Thus, access to the condition repository 130 by the recommendation server 140 may be performed locally. The condition repository 130 is described in greater detail as a hardware implementation with reference to FIG. 3, as part of a cloud implementation with reference to FIG. 4, and/or as utilizing functional abstraction layers for processing with reference to FIG. 5.

In the exemplary embodiments, the property profiles 132 may be associated with available properties that may be habited by the users of the smart devices 110 for a short term, an extended term, or a permanent duration. The property profiles 132 may be populated with information that is manually provided by inspection companies, real estate companies, property owners, etc. The property profiles 132 may also be populated with information that is automatically determined based on various types of available information such as public records. The property profiles 132 may further be populated with information gathered by sensors (not shown) regarding the habitation conditions of the property. The types of information that may be included in the property profiles 132 may include, for example, animals that are currently occupying the property, animals that once occupied the property and a duration since the occupation, noise information surrounding the property both inside and outside, light information from light sources that are present inside the property and outside the property, smell information of different types of smells that are present outside and/or inside the property, a humidity level present inside and/or outside the property, etc.

In the exemplary embodiments, the recommendation server 140 may include a recommendation program 142 and act as a server in a client-server relationship with the property client 112 as well as be in a communicative relationship with the health repository 120 and the condition repository 130. The recommendation server 140 may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of receiving and sending data to and from other computing devices. While the recommendation server 140 is shown as a single device, in other embodiments, the recommendation server 140 may be comprised of a cluster or plurality of computing devices, working together or working independently. The recommendation server 140 is described in greater detail as a hardware implementation with reference to FIG. 3, as part of a cloud implementation with reference to FIG. 4, and/or as utilizing functional abstraction layers for processing with reference to FIG. 5.

In the exemplary embodiments, the recommendation program 142 may be a software, hardware, and/or firmware application configured to provide a plurality of recommendations to the user of the smart device 110 for selected properties being considered. In generating the recommendations, the recommendation program 142 may utilize a health state associated with the user of the smart device 110 as included in the user profile 122 stored in the health repository 120 and habitation conditions associated with a property selected by the user as included in the property profile 132 stored in the condition repository 130. As will be described in exemplary operations, the recommendation program 142 may use the user profile 122 and the property profiles 132 to determine considerations impacting habitation of the property according to the health state of the user, determine whether a selected property is acceptable to the user based on the considerations, and, when the selected property is determined to be unacceptable, determine one or more other properties that may be acceptable to the user and/or determine a request that may make the selected property proper.

According to an exemplary operation, the recommendation program 142 may determine a habitation score of the selected property based on the considerations of the user. The habitation score may be an aggregate score that incorporates the various factors that comprise the considerations and the habitation conditions. Accordingly, the recommendation program 142 may retrieve the user profile 122 of the user and process the health information included therein to identify the considerations. For example, the user may have a condition where a light of a certain luminance triggers a migraine. Accordingly, the recommendation program 142 may identify a consideration as a light sensitivity. In another example, the user may have a relatively severe pet dander allergy. Accordingly, the recommendation program 142 may identify a consideration as an allergic reaction if pet dander is present or sufficient cleaning of a property with pet dander has not been performed. By processing the health information included in the user profile 122, the recommendation program 142 may determine the various considerations that may affect whether the selected property is proper to the user.

The recommendation program 142 may receive an indication of a selected property as selected by the user that is being considered. Based on this indication, the recommendation program 142 may retrieve the property profile 132 of the selected property. The recommendation program 142 may identify a plurality of habitation conditions that may be present at the selected property based on the property profile 132. For example, the recommendation program 142 may determine that the selected property is a short term vacation rental that is pet friendly or where the owner who lives at the selected property owns a pet. The recommendation program 142 may identify the habitation condition that there may be allergy concerns for a prospective user. In another example, the recommendation program 142 may determine that the selected property is a real estate listing that is nearby a commercial zone that is known for high decibel noise during various times of the day. The recommendation program 142 may identify the habitation condition that there may be a noise sensitivity concern for a prospective user. The recommendation program 142 may be configured to identify each of the habitation conditions that may exist at the selected property based on the property profile 132. In an alternative exemplary embodiment, the recommendation program 142 may identify the habitation conditions that are only applicable to the user based on the considerations that are determined based on the user profile 122. In this manner, the recommendation program 142 may omit habitation conditions that may not affect the user or only affect the user up to a tolerable degree.

By determining the considerations of the user and the habitation conditions of the selected property, the recommendation program 142 may generate the habitation score. The habitation score may determine how each consideration is affected by the habitation conditions of the selected property. In this manner, the habitation score may be an aggregate of the different types of considerations that impact the user's acceptability of a given property. The habitation score may be generated using a variety of different mechanisms. In a simplified version, the recommendation program 142 may determine a conflict score for each consideration by determining whether the selected property has a habitation condition that conflicts with the corresponding consideration of the user. The recommendation program 142 may designate a value when there is a conflict (e.g., 0) and when there is no conflict (e.g., 1). After determining each conflict score for each consideration, the recommendation program 142 may take an average of the conflict scores for the set of considerations and generate the habitation score. The habitation score may then be compared to a threshold score (e.g., a minimum tolerance level) to determine if the selected property is acceptable. For example, the threshold score may be 0.5 where a habitation score that is at least the threshold score indicates that the selected property is acceptable whereas a habitation score that is less than the threshold score indicates that the selected property is unacceptable. Those skilled in the art will appreciate that there are various mechanisms that may be used in determining the habitation score and using the habitation score to determine acceptability of the selected property. The recommendation program 142 may also utilize other mechanisms within the scope of the exemplary embodiments.

The recommendation program 142 may include further features with regard to determining whether the selected property is acceptable or within a tolerable limit of the user. For example, the recommendation program 142 may include an overriding mechanism where an existence of a habitation condition that conflicts with a consideration of the user automatically makes the selected property unacceptable. In one manner, the user may provide an indication of a habitation condition that is unacceptable to the user. For such habitation conditions, when the recommendation program 142 determines the existence thereof, the recommendation program 142 may automatically indicate that the selected property is unacceptable even if the habitation score were to satisfy the threshold score. In another manner, the recommendation program 142 may determine a severity of a consideration that may be personal to the user and/or based on a medically identified threshold. For example, the consideration may have a relatively high mortality rate if left untreated (e.g., severe nut allergy). Accordingly, the recommendation program 142 may identify such a consideration as being an overriding factor when determining the acceptability of a selected property. For example, if the user has a severe nut allergy and the selected property is near a nut factory, the recommendation program 142 may determine that the selected property is unacceptable to the user even if the habitation score were to satisfy the threshold score. In this manner, the habitation score may provide an initial gate with regard to acceptability of the selected property while the overriding mechanism may provide a further gate to determine acceptability of the selected property.

Based on the determination of acceptability of the selected property, the recommendation program 142 may perform subsequent operations. As a result of the selected property having a habitation score that satisfies the threshold score with no overriding factors, the recommendation program 142 may transmit an indication to the smart device 110 for this result. The recommendation program 142 may be configured to include other information in the indication. For example, the recommendation program 142 may include the results of the considerations of the user based on the habitation conditions of the selected property. In this manner, the user may be privy to the habitation conditions that impact the considerations of the user. As a result of the selected property having a habitation score that does not satisfy the threshold score or has at least one overriding factor, the recommendation program 142 may transmit an indication to the smart device 110 for this result. Based on this result, the recommendation program 142 may include the results of the considerations of the user based on the habitation conditions. The recommendation program 142 may highlight or emphasize the habitation condition that led to the result of the selected property being unacceptable.

The recommendation program 142 may also be configured to perform further operations when the result of the selected property indicates an unacceptability to the user. For example, the recommendation program 142 may transmit the unacceptable indication to the smart device 110. However, the user may determine that the habitation conditions may only be temporary or fixable. The user may also have a particular liking to the selected property. Accordingly, the user may request that the recommendation program 142 determine a remediation or repair request that alleviates the habitation condition. As a result of receiving the request, the recommendation program 142 may be configured to identify one or more solutions that are to be presented to a responsible member of the selected property (e.g., repair the habitation condition, negotiate price in view of the habitation condition, etc.). The recommendation program 142 may be configured to forward a response from the responsible member to the user of the smart device 110 via the property client 112. In another example, the recommendation program 142 may transmit the unacceptable indication to the smart device 110. The recommendation program 142 may query the user of the smart device 110 if a search should be performed for comparable properties that match any input that was originally provided to include the selected property. When requested by the user, the recommendation program 142 may search the list of available properties that have not been selected by the user and identify one or more comparable properties. The recommendation program 142 may determine the acceptability of the comparable properties to identify the comparable properties that are also acceptable to the user. The recommendation program 142 may filter the acceptable comparable properties to prevent inundating the user with other selections. For example, the recommendation program 142 may utilize the inputs in retrieving the list of available properties. In another example, the recommendation program 142 may identify the comparable properties based on a predetermined range from the selected property. In a further example, the recommendation program 142 may be configured to modify the inputs used in retrieving the list of available properties (e.g., a price range may be modified to include lower or higher priced properties that fall outside the price range up to a predetermined limit). The recommendation program 142 may provide the acceptable comparable properties as additional selections that are available or for comparison purposes. Accordingly, the recommendation program 142 may utilize any of the above features regardless of whether the selected property is determined to be acceptable or not.

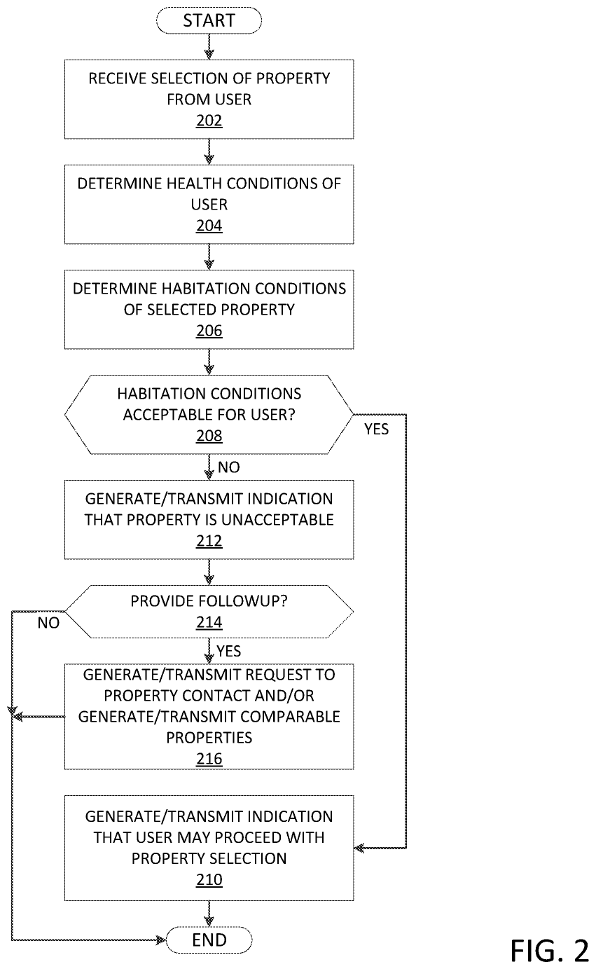

FIG. 2 illustrates an exemplary flowchart of a method 200 illustrating the operations of the recommendation program 142 of the property evaluation system 100 in evaluating a property based on a health state of a user, in accordance with the exemplary embodiments.

The recommendation program 142 may receive a selection of a property from a user of the smart device 110 utilizing the property client 112 (step 202). The user of the smart device 110 may view a listing of available properties that may be provided based on one or more preferences or inputs (e.g., location, price, room requirements, etc.). in viewing the available properties, the user may make one or more selections via the property client 112. The property client 112 may transmit the one more selected properties to the recommendation program 142.

To further illustrate the operations of the delegation program 134, reference is now made to an illustrative exemplary embodiment. According to the illustrative exemplary embodiment, the user may have entered preferences to view real estate properties as a potential purchase. The preferences may have included a price range with a minimum price and a maximum price, a room requirement including a minimum number of bedrooms and full bathrooms, an acreage of the property, etc. The property client 112 may return a list of available properties that match the criteria indicated in the preferences. In viewing the list of available properties, the user may select one or more properties. The recommendation program 142 may receive the selected properties for further processing.

The recommendation program 142 may determine a health state or considerations of the user of the smart device 110 (step 204). In determining the health state or considerations of the user, the recommendation program 142 may retrieve a user profile 122 stored in the health repository 120 that corresponds to the user. The user profile 122 may include various health information from a variety of sources. The recommendation program 142 may process the health information to determine considerations that may impact whether a selected property is acceptable including, for example, health conditions, physical conditions, social conditions, etc.

According to the previously introduced exemplary embodiment, the user profile 122 may be populated with health information based on medical records as kept by medical institutions and/or medical professionals in a manner that complies with HIPAA standards. Based on this health information, the recommendation program 142 may identify considerations that are specific to the user of the smart device 110. For example, the user may be sensitive to noise, especially during late hours. Thus, the user may have a consideration related to noise. In another example, the user may have an allergy to dust that causes airways to close. Thus, the user may have a consideration related to an allergy.

The recommendation program 142 may determine habitation conditions of the selected property (step 206). In determining the habitation conditions of the selected property, the recommendation program 142 may retrieve a property profile 132 stored in the condition repository 130 that corresponds to the selected property. The property profile 132 may include various property information from a variety of sources. The recommendation program 142 may process the property information to determine the habitation conditions that may be present at the selected property.

With reference again to the previously introduced exemplary embodiment, the selected property may lie on a border between a residential zone and a commercial zone. The commercial zone may include factories that may produce noise at all times of the day and may produce dust as a byproduct of the processes being performed. Accordingly, the recommendation program 142 may determine that the selected property may be have habitation conditions where the selected property is prone to noise and likely to have dust present at least outside the selected property.

The recommendation program 142 may determine whether the habitation conditions are acceptable to the user based on the considerations specific to the user (decision 208). The recommendation program 142 may generate a habitation score based on the considerations of the user and the habitation conditions. For example, the habitation score may be an aggregate score based on each consideration and the corresponding habitation condition. The recommendation program 142 may determine whether the selected property is acceptable to the user as a result of the habitation score satisfying a threshold score. The recommendation program 142 may also consider overriding factors that may automatically result in the selected property being determined to be unacceptable to the user. As a result of the selected property being acceptable to the user (decision 208, “YES” branch), the recommendation program 142 may generate and transmit an indication that the user may proceed with the selected property (step 210). The recommendation program 142 may also provide information based on the results in generating the habitation score. As a result of the selected property being unacceptable to the user (decision 208, “NO” branch), the recommendation program 142 may generate and transmit an indication that that the selected property is unacceptable to the user (step 212). The recommendation program 142 may also provide information as to how the result was reached.

Referring now to the previously introduced, illustrative exemplary embodiment, the recommendation program 142 may determine that the noise that is produced by the commercial zone near the selected property does not rise to a level that affects the user in a negative manner (e.g., the noise is reduced during the sensitive time periods of the day). The recommendation program 142 may also determine that the dust being produced by the commercial zone has a parts per million (ppm) that rises above a tolerable level of the user. The recommendation program 142 may generate a habitation score as an average of the results of each consideration. For example, the recommendation program 142 may assign a value for each consideration (e.g., 0 when the consideration conflicts with the habitation condition and 1 when the consideration does not conflict with the habitation condition). In this instance, the recommendation program 142 may determine that the habitation score is 0.5 (e.g., (0+1)/2). The threshold score may be set to 0.5. Thus, based on the habitation score, the recommendation program 142 may determine that the selected property is acceptable for being at least the threshold score. However, the amount of dust that may be present at the selected property may rise to a level that may pose a harmful environment to the user. Thus, the recommendation program 142 may determine that the allergy consideration is an overriding factor that results in the recommendation program 142 determining that the selected property is unacceptable to the user despite the habitation score satisfying the threshold score. Accordingly, the recommendation program 142 may generate and transmit an indication of this result and may also provide the dust information to the user.

As a result of generating and transmitting an indication that the selected property is unacceptable, the recommendation program 142 may determine whether to provide a followup feature to the user (decision 214). For example, the recommendation program 142 may be configured to contact a responsible member for the selected property and suggest remediations that may place the habitation condition in an acceptable form for the consideration of the user. In another example, the recommendation program 142 may be configured to identify comparable properties that may be considered by the user. The recommendation program 142 may determine the comparable properties based on the preferences originally entered by the user. The recommendation program 142 may also modify the preferences to increase a range on an upper end, a lower end, or a combination thereof. The recommendation program 142 may provide an option to the user of the smart device 110 in selecting whether the followup feature to be used. As a result of the followup feature being provided (decision 214, “YES” branch), the recommendation program 142 may generate and transmit a request to the responsible member or contact of the selected property and/or generate and transmit a list of one or more comparable properties to be viewed by the user (step 216).

With reference again to the illustrative exemplary embodiment, the recommendation program 142 may query the user as to whether the user would like further properties to consider or request remediation of the selected property. The user may respond by requesting that both features be performed. The recommendation program 142 may determine that the dust issue at the selected property may only be remediated for the dust particles inside the selected property (e.g., improved sealing on accesses of the property) as the dust present outside the selected property is reasonably only remediated by the factor producing the dust. Thus, the recommendation program 142 may contact a responsible member of the selected property (e.g., a property manager or owner) and request the remediation. The recommendation program 142 may also be configured to expand the ranges of the preferences provided by the user to determine comparable properties to be shown to the user. The recommendation program 142 may also filter the comparable properties to those that are acceptable to the user (e.g., having a habitation score that satisfies the threshold score with no overriding factors).

The exemplary embodiments are configured to evaluate a property to determine whether the property is acceptable to a user based on considerations personal to the user so that the user may proactively determine whether to pursue the property. The exemplary embodiments may utilize health information to identify the considerations where the health information is based on health, physical, and social conditions. The exemplary embodiments may also utilize property information to identify habitation conditions that correspond to the considerations of the user. Based on the considerations of the user and the habitation conditions, the exemplary embodiments may determine the acceptability of the property and whether the property is within a tolerable limit specific to the user.

FIG. 3 depicts a block diagram of devices within the property evaluation system 100 of FIG. 1, in accordance with the exemplary embodiments. It should be appreciated that FIG. 3 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 40 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and evaluation processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for evaluating a prospective property based on a health state of a user, the method comprising:
receiving a selection of the prospective property;
determining one or more considerations based on health information specific to the user, the one or more considerations indicative of one or more conditions that impact habiting the prospective property;
determining habitation conditions based on property information of the prospective property, the habitation conditions indicative of property conditions that are present at the prospective property;
determining whether the prospective property is acceptable to the user based on the one or more considerations and corresponding ones of the habitation conditions; and
transmitting an indication indicating a result of the determining whether the prospective property is acceptable to the user.

2. The computer-implemented method of claim 1, wherein the conditions comprise one or more health conditions, one or more physical conditions, one or more social conditions, or a combination thereof.

3. The computer-implemented method of claim 1, wherein the determining whether the prospective property is acceptable further comprises:
generating a habitation score based on each of the one or more considerations and the corresponding ones of the habitation conditions; and
determining whether the habitation score satisfies a threshold score,
wherein the prospective property is determined to be acceptable when the habitation score is at least the threshold score, and
wherein the prospective property is determined to be unacceptable when the habitation score is less than the threshold score.

4. The computer-implemented method of claim 1, wherein the determining whether the prospective property is acceptable further comprises:
determining whether one of the one or more considerations is an overriding factor; and
as a result of the determined consideration being the overriding factor, determining whether the determined consideration has a conflict with the habitation conditions,
wherein the prospective property is determined to be unacceptable when the determined consideration conflicts with the habitation conditions.

5. The computer-implemented method of claim 1, wherein, as a result of the prospective property being determined to be unacceptable, the method further comprises:
determining a remediation to the prospective property that alleviates the habitation conditions based on the one or more considerations; and
transmitting the remediation in a request to a contact of the prospective property.

6. The computer-implemented method of claim 1, wherein, as a result of the prospective property being determined to be unacceptable, the method further comprises:
determining one or more comparable properties based on the prospective property; and
transmitting the one or more comparable properties to the user.

7. The computer-implemented method of claim 6, wherein each of the one or more comparable properties are determined to be acceptable to the user.

8. A computer program product for evaluating a prospective property based on a health state of a user, the computer program product comprising:
one or more non-transitory computer-readable storage media and program instructions collectively stored on the one or more non-transitory computer-readable storage media capable of performing a method, the method comprising:
receiving a selection of the prospective property;
determining one or more considerations based on health information specific to the user, the one or more considerations indicative of one or more conditions that impact habiting the prospective property;
determining habitation conditions based on property information of the prospective property, the habitation conditions indicative of property conditions that are present at the prospective property;
determining whether the prospective property is acceptable to the user based on the one or more considerations and corresponding ones of the habitation conditions; and
transmitting an indication indicating a result of the determining whether the prospective property is acceptable to the user.

9. The computer program product of claim 8, wherein the conditions comprise one or more health conditions, one or more physical conditions, one or more social conditions, or a combination thereof.

10. The computer program product of claim 8, wherein the determining whether the prospective property is acceptable further comprises:
generating a habitation score based on each of the one or more considerations and the corresponding ones of the habitation conditions; and
determining whether the habitation score satisfies a threshold score,
wherein the prospective property is determined to be acceptable when the habitation score is at least the threshold score, and
wherein the prospective property is determined to be unacceptable when the habitation score is less than the threshold score.

11. The computer program product of claim 8, wherein the determining whether the prospective property is acceptable further comprises:
determining whether one of the one or more considerations is an overriding factor; and
as a result of the determined consideration being the overriding factor, determining whether the determined consideration has a conflict with the habitation conditions,
wherein the prospective property is determined to be unacceptable when the determined consideration conflicts with the habitation conditions.

12. The computer program product of claim 8, wherein, as a result of the prospective property being determined to be unacceptable, the method further comprises:
determining a remediation to the prospective property that alleviates the habitation conditions based on the one or more considerations; and
transmitting the remediation in a request to a contact of the prospective property.

13. The computer program product of claim 8, wherein, as a result of the prospective property being determined to be unacceptable, the method further comprises:
determining one or more comparable properties based on the prospective property; and
transmitting the one or more comparable properties to the user.

14. The computer program product of claim 13, wherein each of the one or more comparable properties are determined to be acceptable to the user.

15. A computer system for evaluating a prospective property based on a health state of a user, the computer system comprising:
one or more computer processors, one or more computer-readable storage media, and program instructions collectively stored on the one or more of the computer-readable storage media for execution by at least one of the one or more processors capable of performing a method, the method comprising:
receiving a selection of the prospective property;
determining one or more considerations based on health information specific to the user, the one or more considerations indicative of one or more conditions that impact habiting the prospective property;
determining habitation conditions based on property information of the prospective property, the habitation conditions indicative of property conditions that are present at the prospective property;
determining whether the prospective property is acceptable to the user based on the one or more considerations and corresponding ones of the habitation conditions; and
transmitting an indication indicating a result of the determining whether the prospective property is acceptable to the user.

16. The computer system of claim 15, wherein the conditions comprise one or more health conditions, one or more physical conditions, one or more social conditions, or a combination thereof.

17. The computer system of claim 15, wherein the determining whether the prospective property is acceptable further comprises:
generating a habitation score based on each of the one or more considerations and the corresponding ones of the habitation conditions; and
determining whether the habitation score satisfies a threshold score,
wherein the prospective property is determined to be acceptable when the habitation score is at least the threshold score, and
wherein the prospective property is determined to be unacceptable when the habitation score is less than the threshold score.

18. The computer system of claim 15, wherein the determining whether the prospective property is acceptable further comprises:
determining whether one of the one or more considerations is an overriding factor; and
as a result of the determined consideration being the overriding factor, determining whether the determined consideration has a conflict with the habitation conditions,
wherein the prospective property is determined to be unacceptable when the determined consideration conflicts with the habitation conditions.

19. The computer system of claim 15, wherein, as a result of the prospective property being determined to be unacceptable, the method further comprises:
determining a remediation to the prospective property that alleviates the habitation conditions based on the one or more considerations; and
transmitting the remediation in a request to a contact of the prospective property.

20. The computer system of claim 15, wherein, as a result of the prospective property being determined to be unacceptable, the method further comprises:
determining one or more comparable properties based on the prospective property; and
transmitting the one or more comparable properties to the user.
